(19) United States
(12) Patent Application Publication
(10) Pub. No.: US 2019/0251750 A1
(43) Pub. Date: Aug. 15, 2019

(54) SYSTEMS AND METHODS FOR USING A VIRTUAL REALITY DEVICE TO EMULATE USER EXPERIENCE OF AN AUGMENTED REALITY DEVICE

(71) Applicant: Tsunami VR, Inc., Del Mar, CA (US)

(72) Inventors: Beth BREWER, Escondido, CA (US); Alexander F. HERN, Del Mar, CA (US)

(21) Appl. No.: 16/266,252

(22) Filed: Feb. 4, 2019

Related U.S. Application Data
(60) Provisional application No. 62/628,860, filed on Feb. 9, 2018.

(51) Int. Cl. G06T 19/00; G06F 3/16; G06F 3/01

(52) U.S. Cl. CPC G06T 19/006; G06F 3/167; G06T 2200/24; G06T 2200/04; G06F 3/017

(57) ABSTRACT

Systems, methods, and computer-readable media for operating a virtual reality (VR) system are disclosed. The VR system can have a VR device associated with a virtual environment to provide a virtual representation of an augmented reality (AR) experience of a physical world. The method can include displaying a portion of the virtual environment on a VR display of the VR device; an emulated AR display of the AR device that would be in view of the user if wearing the AR device in the physical world; and a virtual object representing a physical object inside the image of the AR display. The method can include receiving a user input associated with the virtual object at the VR device. The method can include providing feedback via the VR display based on the user input.

### CROSS REFERENCE TO RELATED APPLICATIONS

This application claims priority to U.S. Provisional Patent Application Ser. No. 62/628,860, filed Feb. 9, 2018, entitled “SYSTEMS AND METHODS FOR USING A VIRTUAL REALITY DEVICE TO EMULATE USER EXPERIENCE OF AN AUGMENTED REALITY DEVICE,” the contents of which are hereby incorporated by reference in their entirety.

### BACKGROUND

### Technical Field

This disclosure relates to virtual reality (VR), augmented reality (AR), and mixed reality (MR) technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology including interactive environments and interactive three-dimensional (3D) virtual objects. Users of MR visualizations and environments can move around the MR visualizations and interact with virtual objects within the virtual environment.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics.

MR, VR, and AR (or similar) devices can provide complex features and high-fidelity of representations of a physical world that can be useful in instruction or various types of training curricula or programs.

### SUMMARY

An aspect of the disclosure provides a method for operating a virtual reality (VR) system. The VR system can have a VR device associated with a virtual environment to provide a virtual representation of an augmented reality (AR) experience of a physical world. The method can include receiving a command to emulate an augmented reality (AR) device by the VR device. The method can include displaying a portion of the virtual environment viewable, on a VR display of the VR device, based on a position and an orientation of a first VR user in the virtual environment. The method can include displaying an image of an AR display of the AR device that would be in view of the user if the user was wearing the AR device in the physical world. The method can include displaying a virtual object representing a physical object inside the image of the AR display. The method can include receiving a user input associated with the virtual object at the VR device. The method can include providing feedback via the VR display based on the user input if the user input matches a predefined interaction of a set of predefined interactions. The method can include displaying an indication that the predefined interactions are completed successfully. The method can include redisplaying the virtual object as manipulated if the user input does not match a predefined interaction of the set of predefined interactions. The predefined interactions can include an ordered sequence of actions based on user input. The user input can include at least one of a voice command, a movement of the user, an interaction with the virtual object, and a controller input to manipulate an AR menu. The predefined interactions can have at least one of work instructions, a maintenance program, an operations program. The method can include displaying an instruction via the image of the AR display to interact with the virtual object.

Another aspect of the disclosure provides a non-transitory computer-readable medium comprising instructions for operating a virtual reality (VR) system including a VR device associated with a virtual environment to provide a virtual representation of an augmented reality (AR) experience of a physical world. When executed by one or more processors the instructions can cause the one or more processors to receive a command to emulate an augmented reality (AR) device by the VR device. The instructions can cause the one or more processors to display a portion of the virtual environment viewable based on a position and an orientation of a first VR user in the virtual environment. The instructions can cause the one or more processors to display an image of an AR display of the AR device that would be in view of the user if the user was wearing the AR device in the physical world. The instructions can cause the one or more processors to display a virtual object representing a physical object inside the image of the AR display. The instructions can cause the one or more processors to receive a user input associated with the virtual object at the VR device. The instructions can cause the one or more processors to provide feedback via the VR display based on the user input if the user input matches a predefined interaction of a set of predefined interactions. The instructions can cause the one or more processors to display an indication that the predefined interactions are completed successfully. The instructions can cause the one or more processors to redisplay the virtual object as manipulated if the user input does not match a predefined interaction of the set of predefined interactions. The predefined interactions can include an ordered sequence of actions based on user input. The user input can include at least one of a voice command, a movement of the user, an interaction with the virtual object, and a controller input to manipulate an AR menu. The predefined interactions can include at least one of work instructions, a maintenance program, an operations program. The displaying can further include, displaying an instruction via the image of the AR display to interact with the virtual object.

Other features and advantages will become apparent to one of ordinary skill following a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of system for creating computer-generated virtual environments and providing the virtual environments as an immersive experience for VR, AR and/or MR users;

FIG. 18 is a functional block diagram of user device for use with the system of FIG. 1;

FIG. 2 is a flowchart of a process for using a virtual reality (VR) device to emulate user experience of an augmented reality (AR) device;

FIG. 3 is a flowchart of a process for using a VR device of a user to present an emulation of an experience the user would have when wearing an AR device while viewing a physical thing;

FIG. 4 is a flowchart of a process for performing an action based on user input designating a movement of the user to a different position and/or orientation in a virtual environment;

FIG. 5 is a flowchart of a process for performing an action based on user input designating an interaction with a virtual object;

FIG. 6 is a flowchart of a process for performing an action based on user input designating an interaction with displayed representations of AR virtual content; and

FIG. 7A through FIG. 7H are graphical representations of different approaches for using a VR display area of a VR device to emulate an AR display area of an AR device.

### DETAILED DESCRIPTION

This disclosure relates to different approaches for using a virtual reality (VR) device to emulate user experience of an augmented reality (AR) device.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics of each of the described embodiments may be combined in any suitable manner in one or more embodiments.

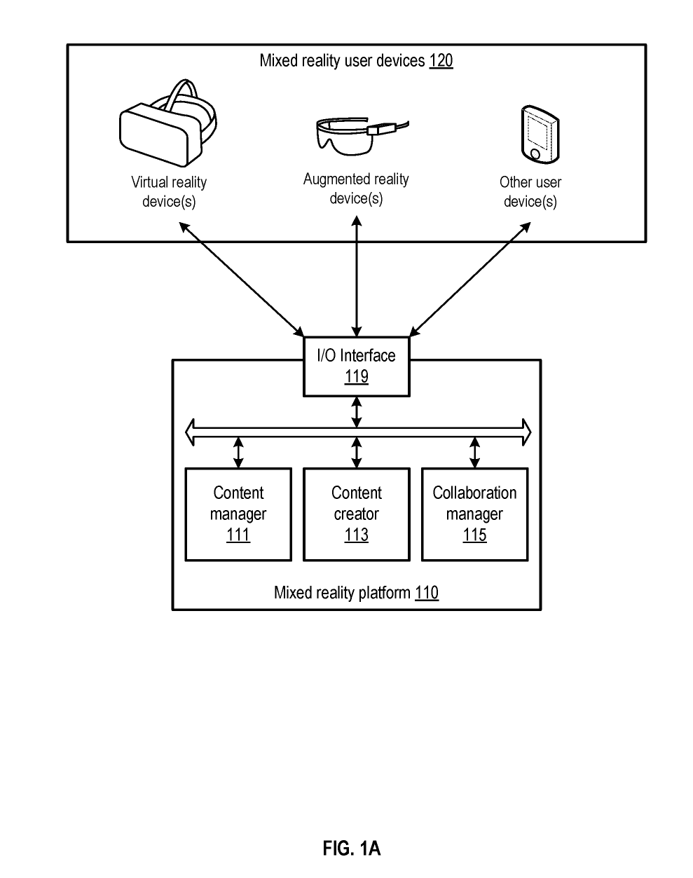

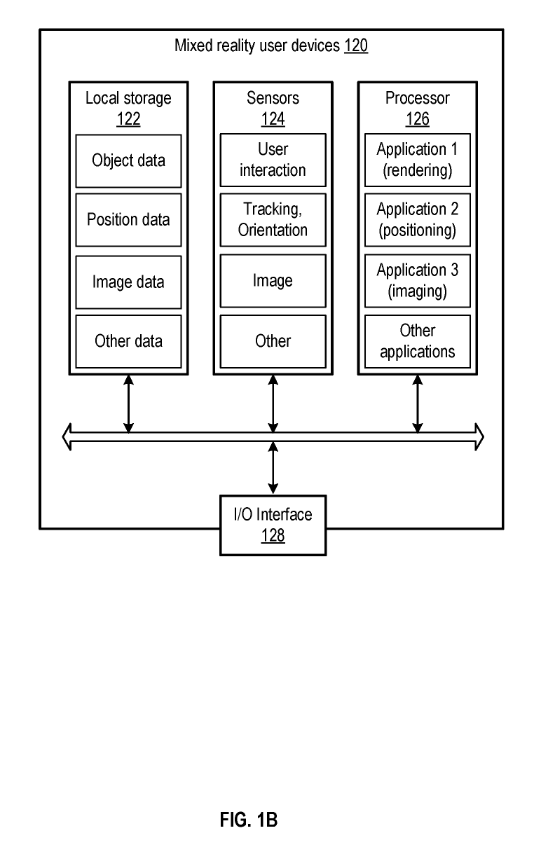

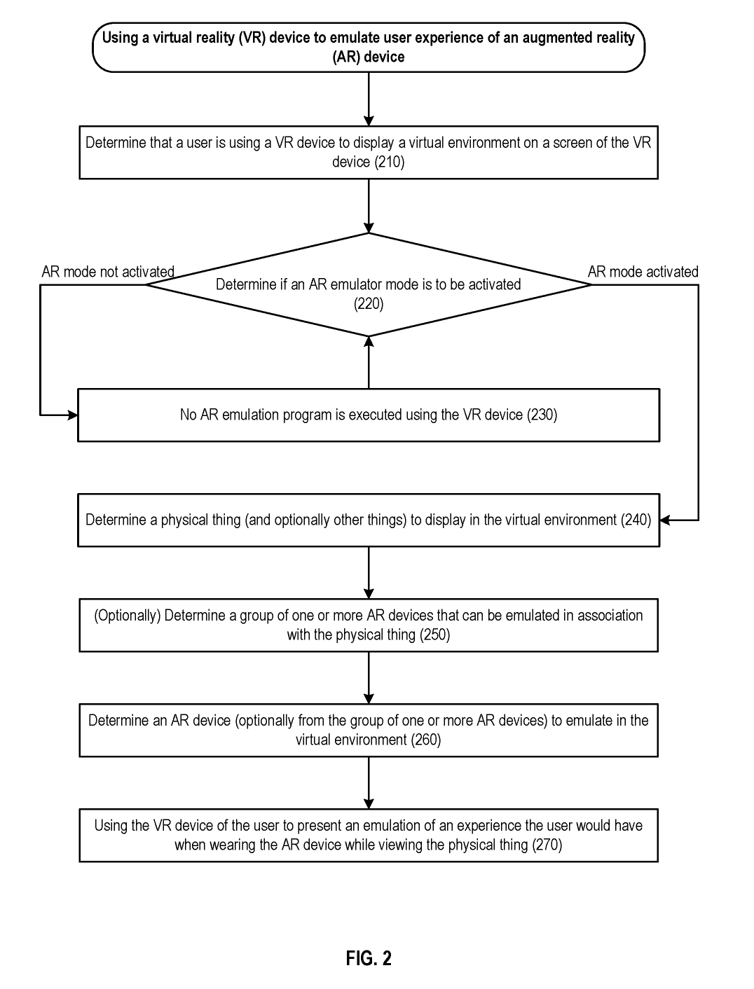

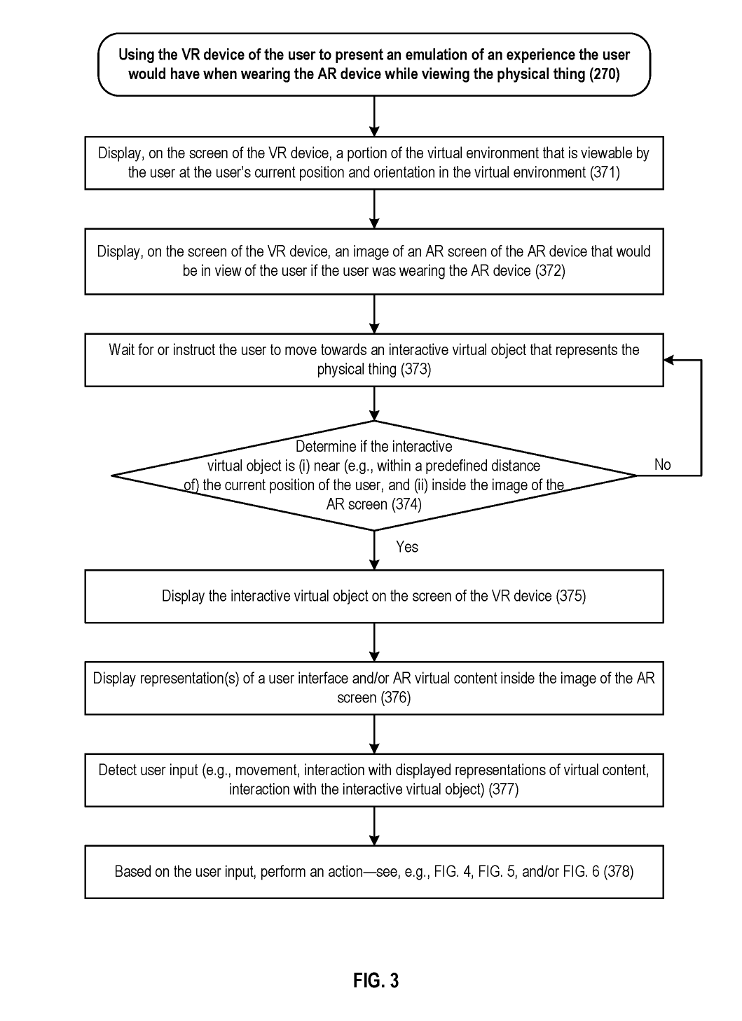

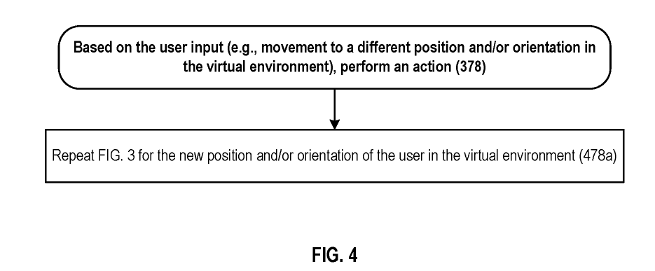

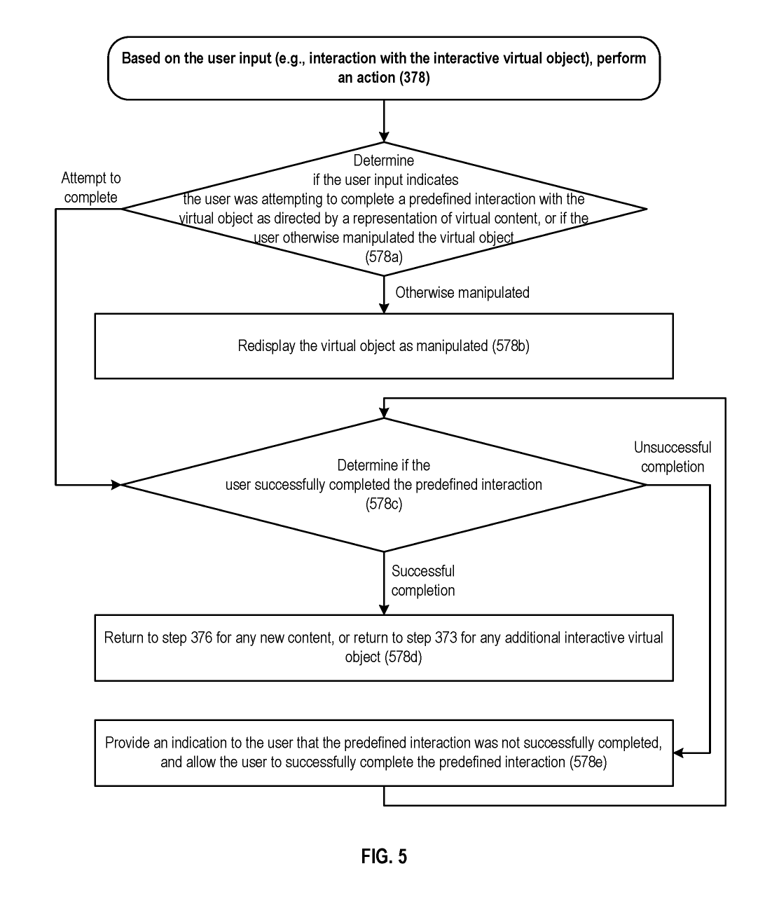

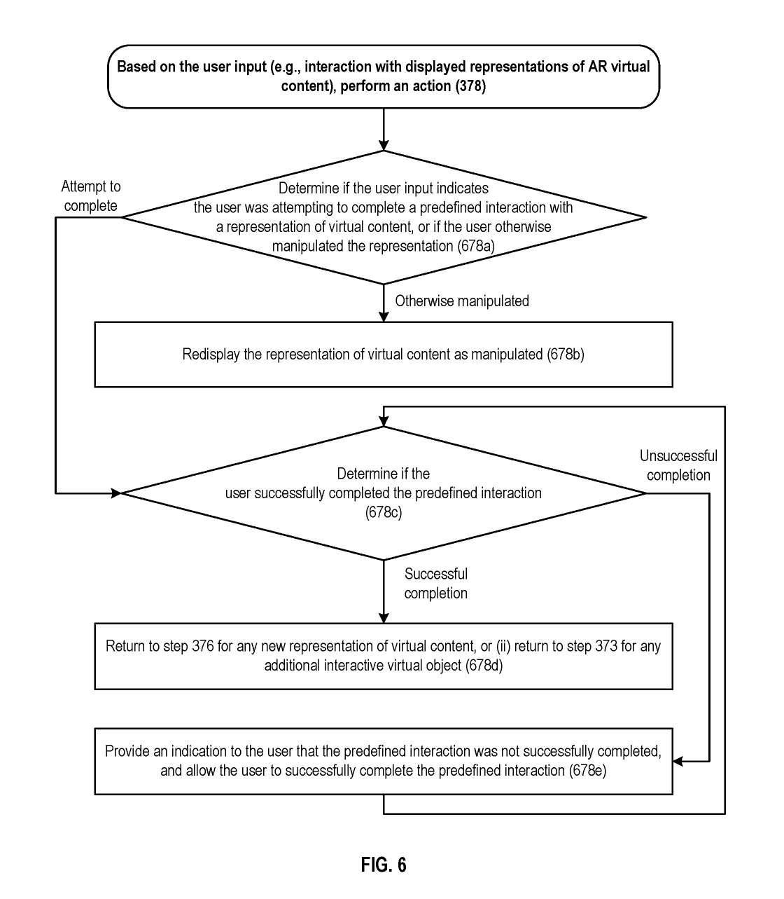

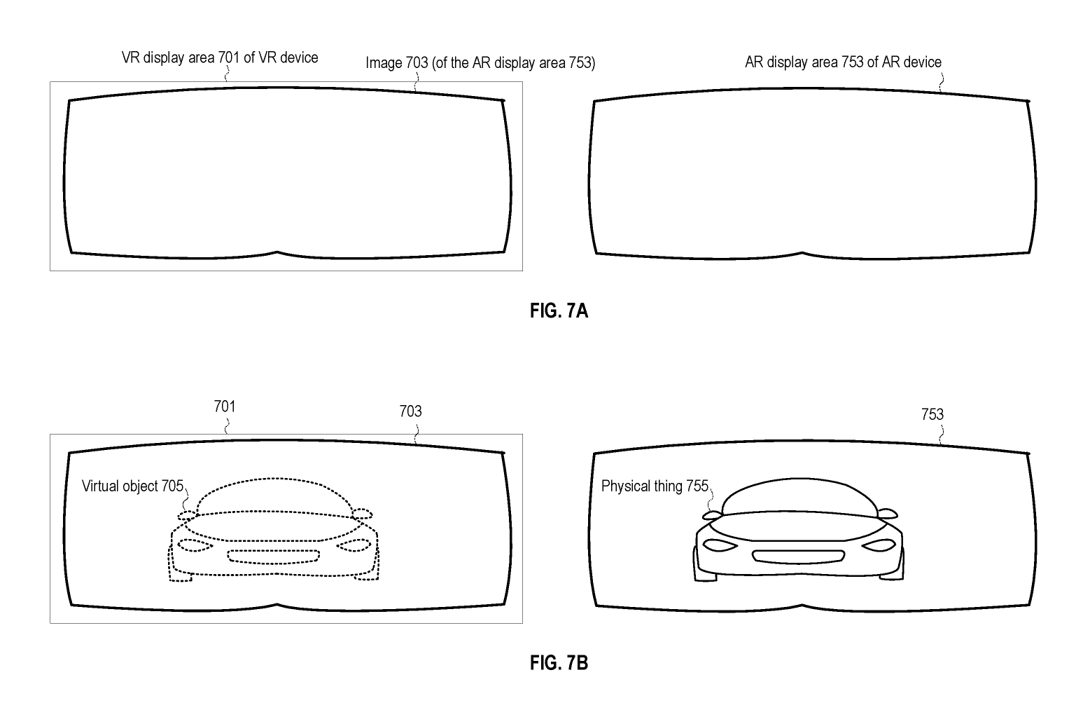

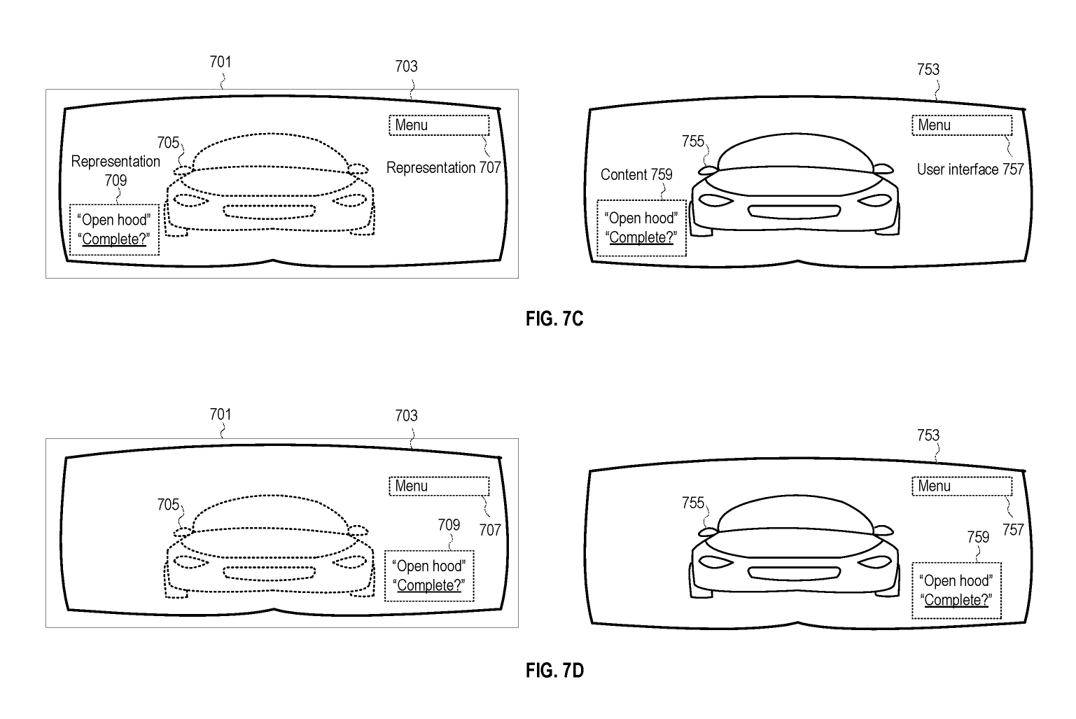

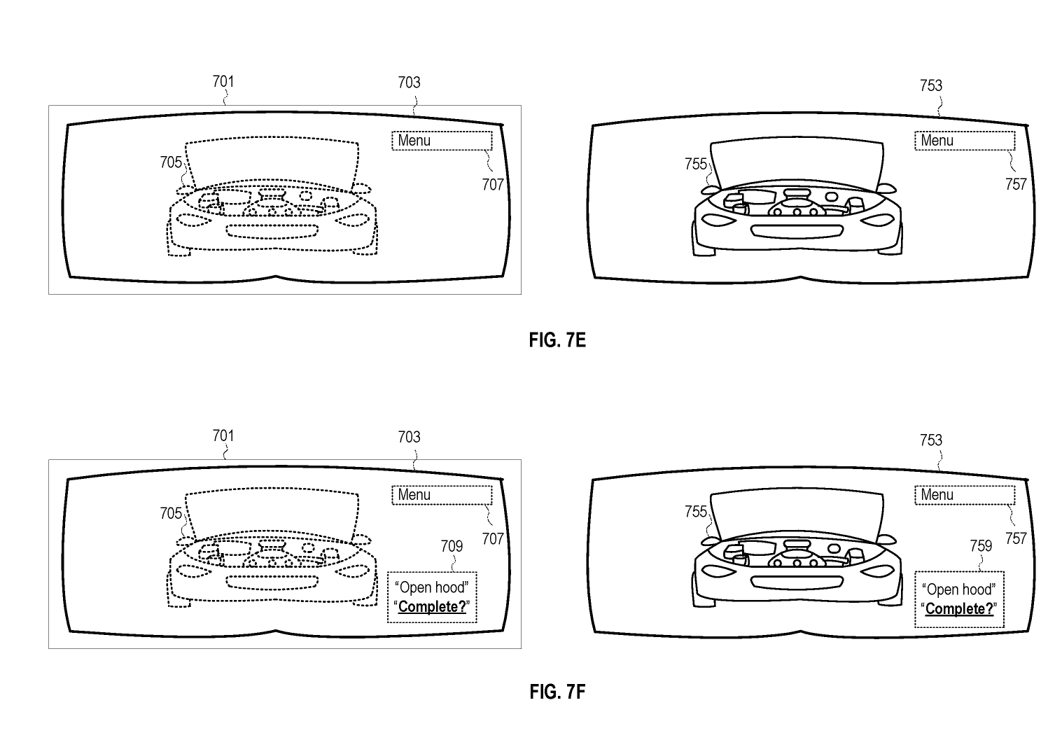

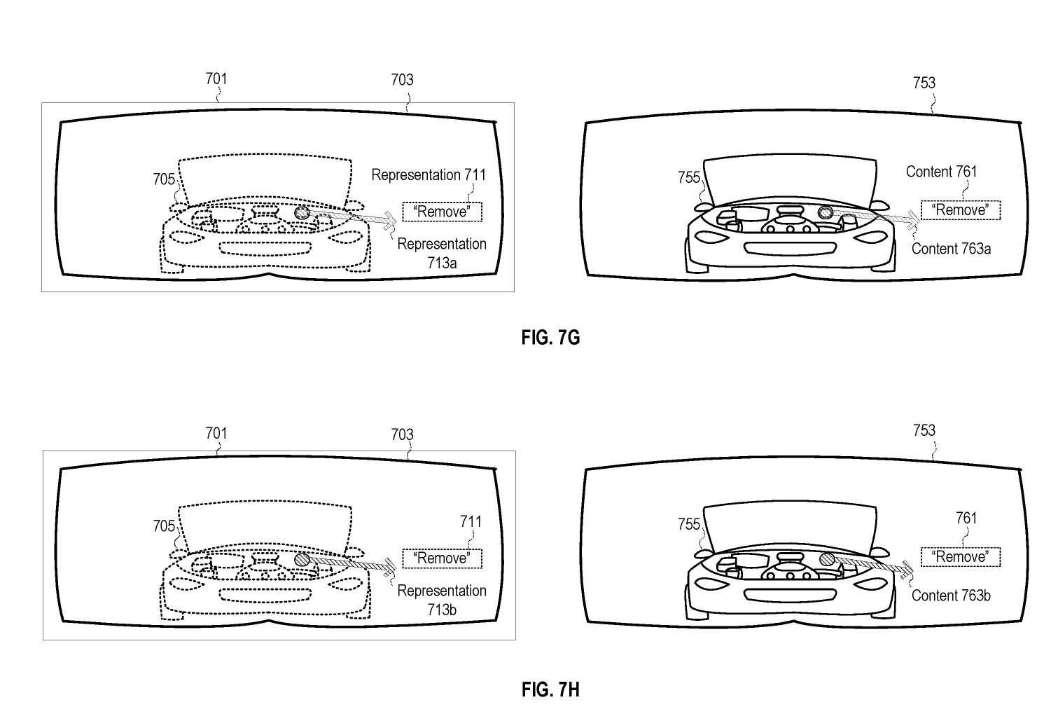

FIG. 1A is a functional block diagram of system for creating computer-generated virtual environments and providing the virtual environments as an immersive experience for VR, AR and/or MR users. Embodiments of the system depicted in FIG. 1A include a system on which a VR device can emulate user experience of an AR device. The system includes a mixed reality platform 110 that is communicatively coupled to any number of mixed reality user devices 120 such that data can be transferred between them as required for implementing the functionality described in this disclosure. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 113 creates a virtual environment, and also creates visual representations of things as virtual content (e.g., virtual objects, avatars, video, images, text, audio, or other presentable data) that can be displayed in a virtual environment depending on a user's point of view. Raw data may be received from any source, and then converted to virtual representations of that data (i.e., virtual content). Different versions of virtual content may also be created and modified using the content creator 113. The content manager 111 stores content created by the content creator 113, stores rules associated with the content, and also stores user information (e.g., permissions, device type, or other information). The collaboration manager 115 provides portions of a virtual environment and virtual content to each of the user devices 120 based on conditions, rules, poses (e.g., positions and orientations) of users in a virtual environment, interactions of users with virtual content, and other information. The I/O interface 119 provides secure transmissions between the platform 110 and each of the user devices 120.

FIG. 1B is a functional block diagram of user device for use with the system of FIG. 1. Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual content or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of user devices 120 include head-mounted displays, AR glasses, smart phones and other computing devices capable of displaying virtual content, and other suitable devices. By way of example, AR devices may include glasses, goggles, a smart phone, or other computing devices capable of projecting virtual content on a display of the device so the virtual content appears to be located in a physical space that is in view of a user.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine fields of view, and each field of view is used to determine what virtual content is to be rendered using the processor 126 for presentation to the user on a display of a user device. Tracking the positions and orientations of the user or any user input device (e.g., a handheld device) may also be used to determine interactions with virtual content. In some embodiments, an interaction with virtual content (e.g., a virtual object) includes a modification (e.g., change color or other) to the virtual content that is permitted after a tracked position of the user or user input device intersects with a point of the virtual content in a geospatial map of a virtual environment, and after a user-initiated command is provided to make the desired modification. Positions in a physical environment may be tracked in different ways, including positioning using Global Navigation Satellite Systems (GNSS), Bluetooth, WiFi, an altimeter, or any other known way to estimate the position of a thing (e.g., a user) in a physical environment.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual content among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, MR and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection or cooperation with the user device(s) 120. The processes can also be performed using distributed or cloud-based computing.

### Using a Virtual Reality (VR) Device to Emulate User Experience of an Augmented Reality (AR) Device

FIG. 2 is a flowchart of a process for using a virtual reality (VR) device to emulate user experience of an augmented reality (AR) device.

As shown in FIG. 2, a determination is made that a user is using a VR device to display a virtual environment on a screen of the VR device (210). Examples of determinations include: the VR device is powered on; or a user logs into an account using the VR device. Examples of virtual reality devices include a virtual reality head mounted display (HMD), a smart phone, a tablet, or other suitable computing device with a screen.

A determination is made if an AR emulator mode is to be activated on the VR device (220). Examples of determining if an AR emulator mode is to be activated include: a menu selection via a user interface of the VR device, clicking on a link received from another user that directs the VR device to the AR emulator mode, opening a file storing an emulation program, or other ways of determining. When a particular emulation program is executed, the AR emulator mode depicts what a user would experience if that user wore a particular AR device while encountering physical things in a physical environment. One particular use of the AR emulator mode is to emulate AR training programs that a user would interact with when later using an AR device in a particular physical environment (e.g., training programs for maintenance, repair and operations (MRO) or other situations). Another use of the AR emulator mode is to emulate a user experience of an AR device during design of that user experience so a designer can evaluate and modify the user experience according to what the emulator presents to the designer on a VR device. Yet another use of the AR emulator is to emulate a user experience with an AR device before a user encounters the experience during future use of an AR device. As used herein, emulating the AR experience can include converting an AR training program (e.g., an AR program, algorithm, predefined set of instructions, etc.) intended for use with an AR user device 120 into a training program or set of instructions/algorithm that creates the look and feel of an AR interface for use on a VR user device.

Different emulation programs can exist for different AR devices, different users of the same AR device, or different physical environments in which the same AR device is used. Each emulation program can do one or more of the following: (i) display a virtual object representing an identified physical thing, (ii) replicate the physical appearance of a screen of an identified AR device as would be seen by a user operating the AR device, (iii) replicate a user interface of that AR device that would be seen by the user operating the AR device, (iv) replicate virtual content displayed on the screen of the AR device during operation of the AR device in association with the physical thing, (v) capture the user movement and/or action in the virtual world and interpret/map the user behavior/action into an action that is known by the emulation program, and (vi) provide an appropriate reaction based on the instructions in the emulation program.

When an AR emulation program is executed by a processor of the VR device, different outputs are displayed on the screen of the VR device. The outputs can include: (i) virtual objects representing physical things that would be encountered when a user operates an AR device in a physical environment that includes the physical things; (ii) an image of any part of the AR device that is (or would be) in view of the user when the user operates the AR device, including an AR screen of the AR device; (iii) representations of different parts of a user interface that appear under different scenarios within the image of the AR screen at locations where the different parts of the user interface would appear when a user operates the AR device; and (iv) representations of virtual content that appear within the image of the AR screen at locations relative to the virtual objects that match locations where the virtual content would appear when the user operates the AR device in view of the physical things represented by the virtual objects. In short, the AR emulation program depicts the appearance of a user experience provided by an AR device when the AR device is operated by a user.

If during step 220, the AR mode is not activated, no AR emulation program is executed using the VR device (230).

If during step 220, the AR mode is activated, a physical thing (and optionally other physical things) to display in the virtual environment is determined (240). Examples of determining a physical thing to display in the virtual environment include (i) selection by the user of the physical thing or a physical location where one or more physical things of interest may be present (e.g., a menu selection via a user interface of the VR device, clicking on a link received from another user that identifies the physical thing, or other ways of selecting), or (ii) identifying a predefined physical thing or a physical location where one or more physical things of interest may be present (e.g., a thing associated with an emulation program that is to be presented to the user of the VR device, where the emulation program may be selected among one or more emulation programs).

The method of FIG. 2 specifies a single physical thing in order to illustrate a simplified example. However, any number of physical things may be determined, including an entire physical environment that contains multiple physical things that may be encountered by the user at a later time when wearing an AR device.

Optionally, a group of one or more AR devices that can be emulated in association with the physical thing is determined (250). The group of AR devices can be determined in different ways. In one implementation, the group of AR devices includes devices that are approved for use with the physical thing or in a physical environment that contains the physical thing (e.g., the group consists of ruggedized AR devices for heavy equipment maintenance, the group consists of AR devices that have the ability to offer particular security features, or other groups). In another implementation, the group of AR devices includes devices that can display particular virtual content relating to the physical thing (e.g., the group consists of AR devices that can track physical things and display information relative to the positions of the tracked physical things).

An AR device (optionally from the group of one or more AR devices) to emulate in the virtual environment is determined (260). Examples of determining an AR device from the group of one or more AR devices to emulate in the virtual environment include (i) selection by the user of the AR device (e.g., a menu selection via a user interface of the VR device, clicking on a link received from another user that identifies the AR device, or other ways of selecting), or (ii) identifying a predefined AR device (e.g., an AR device associated with the emulation program that is to be presented to the user of the VR device).

An emulation of an experience the user would have when wearing the AR device while viewing the physical thing is presented using the VR device of the user (270). One example of step 270, includes displaying on the screen of the VR device: (i) an image of a screen of the identified AR device; (ii) a representation of a user interface of the identified AR device that would be displayed by the screen of the identified AR device during its use in a physical environment; (iii) representations of virtual content that would be displayed by the screen of the identified AR device during its use; and (iv) virtual object(s) that represent physical thing(s) in the physical environment. In some embodiments, a mapping of the physical environment and its physical things is determined, and the mapping is used to generate a virtual environment and virtual objects that virtually represent the physical environment and the physical things where the relative positions and orientations of the virtual objects match the relative positions and orientations of the physical things. The process of step 270 is described in more detail in connection with FIG. 3.

Using a VR Device of a User to Present an Emulation of an Experience the User would have when Wearing an AR Device while Viewing a Physical Thing (270)

FIG. 3 is a flowchart of a process for using a VR device of a user to present an emulation of an experience the user would have when wearing an AR device while viewing a physical thing.

As shown in FIG. 3, a portion of the virtual environment that is viewable by the user at the user's current position and orientation in the virtual environment is displayed on the screen of the VR device (371).

An image of an AR screen of the AR device that would be in view of the user if the user was wearing the AR device is displayed on the screen of the VR device (372). Such an image, and related 3D information/data, may be previously generated and stored before step 270, and later retrieved during step 270. In one implementation, the image of the AR screen is static and can be generated and displayed separately from representations of a user interface or dynamic virtual content (e.g., information about the identified physical thing) that would display on the AR screen if the user wore the selected AR device. Separating images of the AR screen and representations of a user interface and virtual content offers different technical advantages depending on implementation, including: (i) reduction of bandwidth use when transmitting images since the static image of the AR screen need only be transmitted once to the VR device; (ii) reduction of processing needed to render new images at the VR device since the static image of the AR screen may not need to be re-rendered as often as other images; and (iii) reduction of data storage needed to store images since single instances of represented virtual content can be stored for use with different images of different AR screens (as compared to having the same representations of virtual content replicated and saved with different AR screens of different AR devices).

The VR device waits for or instructs the user to move towards an interactive virtual object that represents the physical thing (373).

A determination is made as to whether the interactive virtual object is (i) near (e.g., within a predefined distance of) the current position of the user, and (ii) inside the image of the AR screen (374).

If the virtual object is not near the current position of the user, or is not inside the image of the AR screen during step 374, the process returns to step 373.

If the virtual object is near the current position of the user and is inside the image of the AR screen during step 374, the interactive virtual object is displayed on the screen of the VR device (375).

Representation(s) of a user interface and/or AR virtual content are displayed on the screen of the VR device inside the image of the AR screen (376). Such representations of a user interface and/or AR virtual content may be previously generated and stored before step 270, and later retrieved during step 376. Examples of different AR virtual content that is represented using the VR device include stored information, videos, digital twins, documentation, or images associated with the physical thing (e.g., instructions for operating the thing, instructions for performance maintenance on the thing, options for repairing the thing, methods for performing diagnostics on the thing, options for designing the thing, information about the thing, etc.). As used herein a digital twin is a virtual replica of a physical object, that is, a virtual representation that captures the size, characteristics, composition, color, texture, etc. of a physical object such that the user believes he/she is interacting with the physical object. Examples of a user interface includes information or images that are not associated with the physical thing, but that may be used to control the operation of a program being executed by a device.

By way of example, a sub-step during step 376 of determining where to display a representation of a user interface and/or representations of virtual content may include: (i) identifying a predefined part of the interactive virtual object that is inside the image of the AR screen, and displaying a representation of virtual content at a position relative to the predefined part in the same manner the virtual content would be displayed at a position in the screen of the AR device relative to a part of the physical object that matches the predefined part of the interactive virtual object; (ii) identifying an area inside the image of the AR screen that does not block the user's view of the interactive virtual object, and displaying a representation of a user interface and/or a representation of virtual content in that area; (iii) identifying a location inside the image of the AR screen that is selected by the user, and displaying a representation of virtual content at that location; (iv) identifying a predefined area of the AR screen for displaying a representation of a user interface and/or a representation of virtual content, and displaying the representation of the user interface and/or the representation of the virtual content in that predefined area; and (v) identifying an area that replicates the same area on the AR headset in which the information would be displayed.

User input is detected (377), and an action is performed based on the user input (378). Examples of user input include: movement of the user's position and/or orientation within the virtual environment; interaction by the user with a displayed representation of virtual content; interaction by the user with the virtual object; user speaking a voice command; using the VR controller to perform an action; and user selecting a menu item on the AR user interface.

The AR emulation program interprets the user's action and provides a subsequent reaction which may be: manipulation of the virtual object; an update to the user's view; an update to the displayed AR menu option; a new AR menu being displayed; new virtual objects being displayed; new AR content being displayed within the simulated AR display/headset. An action is performed based on a user input at step (378). Examples of step 378 are provided in FIG. 4, FIG. 5, and/or FIG. 6.

FIG. 4 is a flowchart of a process for performing an action based on user input designating a movement of the user to a different position and/or orientation in a virtual environment. As shown in FIG. 4, the process of FIG. 3 is repeated for the new position and/or orientation of the user in the virtual environment (478a).

FIG. 5 is a flowchart of a process for performing an action based on user input designating an interaction with a virtual object. As shown in FIG. 5, a determination is made as to whether the user input indicates the user was attempting to complete a predefined interaction with the virtual object (e.g., as directed by presented representations of virtual content), or if the user otherwise manipulated the virtual object (578a). A predefined action can include a known action the user can execute with the physical object. For example, the system (e.g., the platform 110) maps the user's action associated a virtual object to determine whether the action is an acceptable (e.g., possible using the platform 110) action with the physical object being simulated. In some implementations, the predetermined interactions can include a series of instructions, for example, a training program for performing repair, operation, and/or maintenance on the physical object. The system maps the series of instructions into a list of actions that the user must execute on the virtual object in order to complete the training. Predefined interactions can be implemented as one or more actions or tasks (e.g., a set of predefined interactions). The predefined interactions can be implemented as in an ordered sequence, for example, in a training program. The predefined interactions can also include a set of actions required to complete a task that may only identify the tasks/actions without specifying a specific ordered sequence. A user (VR or AR user) can provide user inputs to the system in response or according to the predefined actions for a given task.

The predefined interactions, or training program can further include work instructions, maintenance instructions, troubleshooting and repair instructions, operational instructions, design instructions, set of modifications required, “how to” instructions, directional instructions, etc. Any series or set of actions or tasks that can be executed in an AR system can be transformed or otherwise converted and emulated in a VR system. The training program can include instructions that allow a user to learn to operate, for example, an AR user device 120 in an experience-based environment that mimics the real world. This can be particularly useful in situations concerning maintenance training for large equipment that is not easily transported (e.g., oil rigs, large construction equipment, etc.). Thus the system can convert AR data or software elements intended for use with an AR user device into data or other information required to display the same elements in a VR environment viewable using a VR user device.

In some examples, the system can be implemented as a training or evaluation tool for a remote technician, to introduce procedures or evaluate a technician's performance in situations that simulate experiences the technician would encounter in the field (e.g., the real world) while conducting maintenance. In real world operations, the remote technician can be equipped with an AR device for use in conducting actual maintenance, inspections, etc. on equipment in the field. The system therefore, can provide VR-simulated training scenarios and associated instructions for using an actual AR device (e.g., via the emulated AR device on the VR system). This implementation can provide valuable training, simulating the real world environment using the AR system.

If the determination during step 578a is that the user input indicates the user otherwise manipulated the virtual object, then the virtual object is redisplayed on the screen of the VR device as manipulated (578b). Examples of manipulating a virtual object include moving the virtual object (in whole or in part) or other known manipulations. In addition to redisplaying the virtual object in its manipulated form (e.g. opening the hood of a virtual car), the system may display updated AR menu and/or content to provide further instruction to the user. If the determination during step 578a is that the user was attempting to complete a predefined interaction with the virtual object (e.g., as directed by presented representations of virtual content), a determination is made as to whether the user successfully completed the predefined interaction (578c). If completion was determined to be successful during step 578c, the process returns to step 376 for any new representation of content, or returns to step 373 for any additional interactive virtual object (578d). If completion was determined to be unsuccessful during step 578c, the VR device may output an indication that the predefined interaction was not successfully completed, and then wait for the user to successfully complete the predefined interaction by returning to step 578c (578e).

FIG. 6 is a flowchart of a process for performing an action based on user input designating an interaction with displayed representations of AR virtual content. As shown in FIG. 6, a determination is made as to whether the user input indicates the user was attempting to complete a predefined interaction with a representation of virtual content, or if the user otherwise manipulated the representation of virtual content (678a). If the determination during step 678a is that the user input indicates the user otherwise manipulated the representation of virtual content, then the representation of virtual content is redisplayed on the screen of the VR device as manipulated (678b). Examples of manipulating representations of virtual content include moving (in whole or in part), removing a part, resizing, changing the appearance, or other known manipulations. If the determination during step 678a is that the user was attempting to complete a predefined interaction with the representation of virtual content, a determination is made as to whether the user successfully completed the predefined interaction (678c). If completion was determined to be successful during step 678c, the process returns to step 376 for any new representation of content, or returns to step 373 for any additional interactive virtual object (678d). If completion was determined to be unsuccessful during step 678c, the VR device may output an indication that the predefined interaction was not successfully completed, and then wait for the user to successfully complete the predefined interaction by returning to step 678c (678e).

Illustrations of different approaches for using a VR display area of a VR device to emulate an AR display area of an AR device

FIG. 7A through FIG. 7H are graphical representations of different approaches for using a VR display area of a VR device to emulate an AR display area of an AR device.

FIG. 7A through FIG. 7H illustrate different approaches for using a VR display area 701 of a VR device to emulate an AR display area 753 of an AR device. In each of FIG. 7A through FIG. 7H, the VR display area 701 is shown at left, and the AR display area 753 that is emulated by the VR device is shown at right.

FIG. 7A is a when an image 703 of the AR display area 753 is displayed in the VR display area 701—e.g., step 372 of FIG. 3. The image 703 is provided to mimic the shape, size and other physical characteristics (e.g., color) of the AR display area 753 that a user would see if the user wore the AR device that has the AR display area 753.

FIG. 7B illustrates emulation of a physical thing 755 seen through the AR display area 753 from a particular position in a physical environment. As shown in FIG. 7B, a virtual object 705 representing the physical thing 755 is generated using known techniques, and presented in the VR display area 701—e.g., step 375 of FIG. 3.

FIG. 7C illustrates emulation of a user interface 757 that would display on the AR device area 753 when a user wears the AR device that has the AR display area 753, and also emulation of virtual content 759 (e.g., directions for the user to make a predefined action relative to the physical thing 755) that would display on the AR device area 753 when a user wears the AR device when the physical thing 755 is within a predefined distance of the user in a physical environment. As shown in FIG. 7C, a representation 707 of the user interface 757 is generated and presented in the VR display area 701—e.g., step 376 of FIG. 3. Also, a representation 709 of the virtual content 759 is generated and presented in the VR display area 701 when the virtual object 705 is within the predefined distance of the user's position in a virtual environment that virtually represents the physical environment—e.g., step 376 of FIG. 3. By way of example, the content 759 directs the user to complete a predefined action relative to the physical thing 755, and the representation 709 directs the user to complete the predefined action or a similar predefined action relative to the virtual object 705. As shown in FIG. 7C, the representations 707 and 709 are provided to respectively mimic the user interface 757 and the content 759 that a user would see if the user wore the AR device if the user is at a particular distance from the physical thing 755.

FIG. 7D illustrates emulation of a user's interaction with the virtual content 759 while wearing the AR device, where the interaction is not a predefined action (e.g., the interaction is movement of the content 759 to a new location on the AR device area 753)—e.g., steps 377 and 378 of FIG. 3; step 678b of FIG. 6. As shown in FIG. 7D, a user operating the VR device with the VR display area 701 moves the representation 709 to a new location such that the representation 709 is presented in the VR display area 701 in the new location. The actions taken by the user to move the representation 709 mimic actions taken by a user to move the content 759 (e.g., known user gestures or commands selecting and moving the representation 709 are the same user gestures or commands selecting and moving the content 759). Examples of actions taken by the user to move the representation 709 or the content 759 include tracked finger movements, spoken words, or other known techniques to select and move the content 759 or representation 709.

FIG. 7E illustrates emulation of what happens in some embodiments after a user performs a first predefined action in relation to the physical thing 755 (e.g., the user opens the hood of the physical car) while wearing the AR device that has the AR display area 753. As shown in FIG. 7E, the content 759 is no longer displayed after the first predefined action is detected (e.g., detection by a visual sensor and image processing capability of the AR device that recognizes the first predefined action). Similarly, the representation 709 is no longer displayed after a second predefined action in relation to the virtual object 705 is detected (e.g., the user of the VR device performs a gesture that opens the hood of the virtual car, which is detected by a visual sensor and image processing capability of the VR device, by a user input tool like a controller, or other suitable means of the VR device that recognizes the second predefined action)—e.g., steps 377 and 378 of FIG. 3; steps 578c and 578d of FIG. 5.

Different predefined actions can be used in different embodiments, including: (i) a movement by the user relative to the physical thing or the virtual object that is respectively recognized by the AR device or the VR device (e.g., using a visual sensor and image processing capability of that AR or VR device, or using tracked movement of a tracking device worn, held or otherwise coupled to the user when the user uses the AR device or the VR device); (ii) a movement by the physical thing or a part of the physical thing that is recognized by the VR device or AR device (e.g., using a visual sensor and image processing capability of the VR device or AR device, or using tracked movement of a tracking device attached to the physical thing); (iii) a sound, a light, or other output by the physical thing that is recognized by the VR device or AR device (e.g., using an appropriate sensor); and/or (iv) an input received from the user (e.g., a voice command, an audio input, a selection of a displayed option relative to the content or representation of content, a selection of the virtual object or part of the virtual object).

In different embodiments: (i) the first and second predefined actions are the same and detected using similar technology (e.g., a visual sensor and image processing capability of the AR device and the VR device); (ii) the first and second predefined actions are the same, but the first and second predefined actions are detected using different technology (e.g., the AR device uses a visual sensor and image processing capability, and the VR device tracks the movement of the user using other technology such as movement of device worn, held or otherwise coupled to the user); (iii) the first and second predefined actions are not the same but similar (e.g., the first predefined action is a first recognized movement by the user of the physical thing, and the second predefined action is a second recognized movement by the user of the virtual object); or (iv) the first and second predefined actions are not the same or similar (e.g., the first predefined action is a first recognized movement by the user or the physical thing, and the second predefined action is a non-movement action such as a spoken command like “completed” or “advance to next step”).

FIG. 7F illustrates emulation of what happens in some embodiments after a user performs a first predefined action in relation to the virtual content 759 (e.g., the user selects an option displayed on the AR display area 753, such as an option designating the user “completed” a suggested action). As shown in FIG. 7F, the user selects a selectable option of content 759 (i.e., as designated by the bold “Complete?”), after which the content 759 would no longer display. Similarly, the user selects a selectable option of representation 709 (i.e., as designated by the bold “Complete?”), after which the representation 709 would no longer display—e.g., steps 377 and 378 of FIG. 3; steps 678c and 678d of FIG. 6. In different embodiments, selection of the option occurs in different ways (e.g., speaking “completed”, making a gesture selecting “Complete?”, directing a controller to select “Complete?” or another user-initiated input).

In one embodiment, the representation 709 and the content 759 are removed only after respective predefined actions with the virtual object 705 and the physical thing 755 are detected, and respective predefined actions with the representation 709 and the content 759 are detected.

FIG. 7G and FIG. 7H are graphical representations of embodiments in which new content (e.g., content 761 and content 763) is displayed after a previous predefined action has been completed during operation of the AR device. As shown in FIG. 7G and FIG. 7H, the representation 709 is no longer displayed, a representation 711 of the new content 761 is displayed, and a representation 713 of the new content 763 is displayed—e.g., step 376 of FIG. 3 (repeated for the new representation(s) of content).

FIG. 7G illustrates emulation of what happens in some embodiments when content (e.g., the content 763a) is presented in front of the physical thing 755 as a semi-transparent image such that portions of the physical thing 755 behind the content 763a can be seen. As shown in FIG. 7G, the representation 713a is similarly presented in front of the virtual object 705 as a semi-transparent image such that portions of the virtual object 705 behind the representation 713a can be seen.

FIG. 7H illustrates emulation of what happens in some embodiments when content (e.g., the content 763b) is presented in front of the physical thing 755 as a non-transparent image such that portions of the physical thing 755 behind the content 763a cannot be seen. As shown in FIG. 7H, the representation 713b is similarly presented in front of the virtual object 705 as a non-transparent image such that portions of the virtual object 705 behind the representation 713a cannot be seen.

### Additional Embodiment

The following steps are carried out in an additional embodiment:
1. A user starts an AR emulator, which may be in the form of a single application, loading a particular virtual environment, or starting a VR device and selecting an option to invoke an AR emulator mode.
2. The system (e.g., VR device and/or platform) determines which type of AR headset to emulate, which can be user selected, predefined by the user or system (e.g. if the system only supports one type), predefined by the virtual environment, or may be defined as a part of meta data associated with an AR emulator program.
3. The system renders the background virtual environment and objects that are in the user's view and overlays a virtual replica of the determined type of AR headset as would be seen by a user while wearing the AR headset (e.g. the virtual replica may show the frame or rim or other physical features of the AR headset that would be seen by the user if the user wore the AR headset). The rendering of the virtual replica of the AR headset is static, which means the user can see through the virtual replica of the AR headset into the virtual environment regardless of where the user is looking. The system also overlays a virtual representation of the AR headset's user interface (UI) and virtual content as they would appear in the AR headset.
4. As the user moves (e.g., rotates position of head, moves position of eyes, move position of body) around the virtual environment while wearing the VR device, representations of the UI and the virtual content are updated according to data associated with the virtual objects that the user is looking at or near.
5. As the user moves, the system determines if: (a) the user is making a gesture to control the represented UI or to interact with the represented virtual content, (b) if the user is interacting with a virtual object, or (c) if the user is just moving in the virtual environment.
6. When the system determines the user is making a gesture to control the represented UI or to interact with the represented virtual content, the gesture is identified. If the gesture is applicable to the menu of the represented UI or is applicable to the represented virtual content that is displayed, the system updates the represented UI or represented virtual content accordingly. If the gesture is not applicable, an error is displayed or the gesture is ignored. This behavior is identical to the behavior that the AR headset would exhibit in the physical world. The gestures or user input that would be used to navigate the UI of the AR device would be implemented in a similar manner for the represented UI displayed on the VR device, but within the limitations of the VR device. For example, if an input on the side of the AR device would be selected to perform a function in the physical world and a VR device (e.g., VR HMD) does not support an input on the side of the VR device (e.g., a touchpad on the side the VR HMD), then another form of input would be implemented. (e.g., selection of another input elsewhere such as on a controller held by the user of the VR HMD, or selection of an input positioned elsewhere on the VR HMD). By way of another example, if the VR device (e.g., VR HMD) does not support a front facing camera, and therefore user gesture recognition (e.g., movements of the user's hand and/or finger) may not be supported, then another form of user input via the VR device is implemented (e.g., user selection of an input of the VR device, tracking of the movement using a different type of sensor other than a front facing camera).
7. When the system determines that the user is interacting with a virtual object, the system performs object determination/identification using known approaches for determining/identifying objects. In one implementation, the VR device performs the object determination in a similar manner as an AR device determines physical objects in the physical environment (e.g., relative location based on a spatial mapping, comparison the physical object to virtual replicas, etc.). After an object has been identified, represented virtual content about the object is displayed and any associated menu items that can be selected relative to the object are displayed. When the user continues to interact with the object, the represented UI and virtual content are updated accordingly. For example, if the user opens a compartment on the object and internal components of the object are revealed, then additional information may be displayed relating to the internal components in the form of represented virtual content.
8. When the system determines the user is moving about in the virtual environment, the system updates the represented UI according to the behavior the AR UI would exhibit in the physical environment.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies.

Methods of this disclosure may be implemented by hardware, firmware or software.

One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. One or more machines that are configured to perform the methods or operations comprising the steps of any methods described herein are contemplated.

Systems that include one or more machines and the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for operating a virtual reality (VR) system including a VR device associated with a virtual environment to provide a virtual representation of an augmented reality (AR) experience of a physical world, the method comprising:
receiving a command to emulate an augmented reality (AR) device by the VR device;
displaying, on a VR display of the VR device,
a portion of the virtual environment viewable based on a position and an orientation of a first user in the virtual environment,
an image of an AR display of the AR device that would be in view of the user if the user was wearing the AR device in the physical world, and
a virtual object representing a physical object inside the image of the AR display;
receiving a user input associated with the virtual object at the VR device;
providing feedback via the VR display based on the user input if the user input matches a predefined interaction of a set of predefined interactions.

2. The method of claim 1, further comprising displaying an indication that the set of predefined interactions are completed successfully.

3. The method of claim 1, further comprising redisplaying the virtual object as manipulated if the user input does not match a predefined interaction of the set of predefined interactions.

4. The method of claim 1 wherein the set of predefined interactions comprise an ordered sequence of actions based on additional user input.

5. The method of claim 1 wherein the user input comprises at least one of a voice command, a movement of the user, an interaction with the virtual object, and a controller input to manipulate an AR menu.

6. The method of claim 1 further comprising converting an AR training program intended for use with the AR device into a training program having a look and feel of an AR interface for use on the VR user device.

7. The method of claim 1, wherein the displaying further comprises, displaying an instruction via the image of the AR display to interact with the virtual object.

8. The method of claim 1, further comprising displaying the virtual object when the virtual object falls within a predefined distance of the position of the user in the virtual environment and within the image of the AR display.

9. The method of claim 1, further comprising:
detecting user movement; and
repeating the displaying for a second user position and orientation in the virtual environment.

10. The method of claim 1, further comprising:
displaying an AR user interface on the screen of the VR device; and
displaying AR virtual content within the image of the AR display.

11. A non-transitory computer-readable medium comprising instructions for operating a virtual reality (VR) system including a VR device associated with a virtual environment to provide a virtual representation of an augmented reality (AR) experience of a physical world, that when executed by one or more processors cause the one or more processors to:
receive a command to emulate an augmented reality (AR) device by the VR device;
display on a VR display of the VR device,
a portion of the virtual environment viewable based on a position and an orientation of a first user in the virtual environment,
an image of an AR display of the AR device that would be in view of the user if the user was wearing the AR device in the physical world, and
a virtual object representing a physical object inside the image of the AR display;
receive a user input associated with the virtual object at the VR device;
provide feedback via the VR display based on the user input if the user input matches a predefined interaction of a set of predefined interactions.

12. The non-transitory computer-readable medium of claim 11 further comprising instructions that cause the computer to display an indication that the predefined interactions are completed successfully.

13. The non-transitory computer-readable medium of claim 11 further comprising instructions that cause the computer to redisplay the virtual object as manipulated if the user input does not match a predefined interaction of the set of predefined interactions.

14. The non-transitory computer-readable medium of claim 11, wherein the predefined interactions comprise an ordered sequence of actions based on additional user input.

15. The non-transitory computer-readable medium of claim 11, wherein the user input comprises at least one of a voice command, a movement of the user, an interaction with the virtual object, and a controller input to manipulate an AR menu.

16. The non-transitory computer-readable medium of claim 11, wherein the predefined interactions comprise at least one of work instructions, a maintenance program, an operations program.

17. The non-transitory computer-readable medium of claim 11, wherein the displaying further comprises, displaying an instruction via the image of the AR display to interact with the virtual object.

18. The non-transitory computer-readable medium of claim 11 further comprising instructions that cause the computer to display the virtual object when the virtual object falls within a predefined distance of the position of the user in the virtual environment and within the image of the AR display.

19. The non-transitory computer-readable medium of claim 11 further comprising instructions that cause the computer to:
detect user movement; and
repeat the displaying for a second VR user position and orientation in the virtual environment.

20. The non-transitory computer-readable medium of claim 11 further comprising instructions that cause the computer to:
display an AR user interface on the screen of the VR device; and
display AR virtual content within the image of the AR display.
